(19) United States
(12) Patent Application Publication
(10) Pub. No.: US 2026/0264294 A1
(43) Pub. Date: Sep. 10, 2026

(54) METHOD AND SYSTEM FOR OBTAINING A PURIFIED PLASTIC MATERIAL FROM A MIXED WASTE MATERIAL STREAM

(71) Applicant: TOMRA SORTING GMBH, Mülheim-Kärlich (DE)

(72) Inventors: Hans Jürgen PRIESTERS, Schleiden (DE); István László SZÉKELY, Hallschlag (DE)

(73) Assignee: TOMRA SORTING GMBH, Mülheim-Kärlich (DE)

(21) Appl. No.: 19/491,356

(22) PCT Filed: Jun. 14, 2024
(86) PCT No.: PCT/EP2024/066656

§ 371 Date: Dec. 8, 2025

(30) Foreign Application Priority Data
Jun. 22, 2023 (EP) 23180862.7

(51) Int. Cl. B29B 17/02; B07C 5/342; B29B 17/00; B29B 17/04; B29K 25/00

(52) U.S. Cl. CPC B29B 17/02; B07C 5/3425; B29B 17/0412; B07C 2501/0054; B29B 2017/0015; B29B 2017/0279; B29K 2025/06

(57) ABSTRACT

The present disclosure relates to a method for obtaining a purified plastic material from a mixed waste material stream. The method comprises discriminating a first type of plastic material using a near infrared spectroscopy system. Diverting said first type of plastic material into a first type of plastic material fraction. Reducing the size of the material items of the first type of plastic material fraction. Subjecting the first type of plastic material fraction for a washing process. Discriminating the washed first type of plastic material fraction and diverting the washed first type of plastic material fraction, thereby obtaining the purified plastic material. The present disclosure further relates to a system for obtaining a purified plastic material from a mixed waste material stream.

### FIELD OF INVENTION

The present invention generally relates to a method for obtaining a purified plastic material from a mixed waste material stream. The present invention also generally relates to a system for obtaining a purified plastic material from a mixed waste material stream.

### TECHNICAL BACKGROUND

Food packages, bottles and containers are just some examples of products that may be made out of plastic. Plastic materials are advantageous as material due to its many advantageous properties e.g. it is a light material, it resists water and has a long lifetime. The combination of these properties result in that plastic material is extensively used and needed in many industries, but when the plastic material ends up in the nature it causes problems for the plant and wildlife. Thus, it is important that the used plastic is gathered and sent to a dump.

Usually, the plastic that reaches the dump is sent to incineration, landfilling, or is recycled, through chemical or mechanical processes. Those are currently the main techniques used to manage plastic waste. However, there are many problems associated with managing plastic waste. One problem is that high value materials are lost and cannot be used further if plastic waste is incinerated. Another problem related to incineration of plastics resides in that the incineration process produces many products that are harmful to humans and the environment such as carbon monoxide, carbon dioxide, chlorine, and other hydrocarbons. These gases also contribute to the problem with global warming. A problem with discarding plastics waste in landfills is that it takes up landfill space and that it is labour intensive. Further, plastics discarded in landfills are prone to releasing harmful substances over time. Moreover, waste-to-energy conversion is not efficient when discarding plastics waste.

Therefore, recycling is a good way to take care of plastic waste. When recycling plastic, the purity levels for various types of plastic is important or else the final product will suffer from an inferior quality. For instance, it is not possible to achieve a high-quality recycled plastic if the recycled material is formed of a mix of different materials, such as different types of plastic. Thus, it is of high importance that the plastic waste is sorted properly based on for instance type and origin. Various processes may be used for sorting the plastic into different fractions. However, the existing processes are generally too labour-intensive, and the plants used are not flexible enough to be adapted to different conditions. Further, the existing processes are not able to achieve high enough purity levels for each plastic type or fraction. This results in that plastic materials sorted by existing methods cannot generally be used for forming virgin plastics when being recycled. In other words, recycled plastics are typically degraded in quality and or purity and cannot be used for the same purpose as before being recycled. An example of material that would be beneficial to use in the same usage area is high impact polystyrene plastic used for food packaging. There is a need of a more accurate method for sorting out these types of plastic products with a high efficiency and with a high purity level in the resulting fraction in both an efficient and effective way.

### SUMMARY OF INVENTION

In view of the above, it is an object of the present disclosure to provide an improved method for obtaining a purified plastic material from a mixed waste material stream.

It is also an object of the present disclosure to provide an improved system for obtaining a purified plastic material from a mixed waste material stream.

It is also an object to provide a solution that addressees at least some of the criteria described above, namely, to provide a solution that can recover or sort a mixed waste material stream into different fractions with a higher precision, creating higher purity level of desired plastic material.

A further object is to provide a method that is able to sort out a number of different plastic materials from each other into separate fractions with a higher efficiency.

To achieve at least one of the above objects, and also other objects that will be evident from the following description, a method having the steps defined in claim 1 is provided according to the present disclosure. Preferred variants of the method will be evident from the dependent claims.

More specifically, there is provided according to a first aspect a method for obtaining a purified plastic material, such as a high impact polystyrene material, from a mixed waste material stream. The method comprising, discriminating a first type of plastic material from other types of material in the material stream using a near infrared spectroscopy system and/or a visible spectroscopy system, diverting the first type of plastic material from other types of material in the material stream into a first plastic material fraction, thereby sorting out material of the first type of plastic material from the material stream, reducing a size of material items in the first type of plastic material fraction, subjecting the first type of plastic material fraction to an alkaline washing process and/or a washing process at an elevated temperature, discriminating said first type of plastic material in the washed first type of plastic material fraction from other types of material using a near infrared spectroscopy system and/or a visible spectroscopy system, and diverting said first type of plastic material in the washed first type of plastic material fraction from other types of material, thereby sorting out other types of material from the washed first type of plastic material fraction, thereby obtaining the purified plastic material.

The method may be advantageous in that the second discriminating and diverting steps are performed subsequent to the step of reducing the size of the material in the first type of plastic material fraction and subsequent to subjecting the first type of plastic material fraction to a washing process, which increases the level of purity in the obtained purified plastic material. The material items in the sorted first type of plastic material fraction may prior to reducing its size be of mixed type. In other words, material items or objects in the sorted first type of plastic material fraction may include more than one type of material where the one or more types of material are bound together prior to reducing a size of the items. By reducing the size of the material items material of different types may be split from each other which result in that the second discriminating and diverting step may be allowed to sort more accurately with a higher purity as a result. Further, the washing step may remove stickers, signs or similar on the material in the first type of plastic material fraction, thereby allowing the subsequent discriminating and the diverting steps to remove these as well. Hence, a higher purity may be achieved. The first sorting made in the first discriminating and diverting steps result in that a reduced amount of material reaches the step of reducing the size and that a better result may be achieved when the second discriminating and diverting steps are performed. The higher purity of the plastic material may result in an end product with a higher quality.

The input material, that is the mixed waste material stream, may originate from bales of mixed waste material or bales of plastic material. The origin of the material may be from municipal solid waste. The municipal solid waste may have already been sorted in a municipal solid waste plant.

When discriminating the first type of plastic material from other types of material the discrimination may be done dependent on the composition of the first type of plastic material. The material type may also be combined with the colour, such that the first type of plastic material may be of a specific composition with a specific colour. When the first type of plastic material is discriminated it is diverted into the first type of plastic material fraction based on the information from the step of discrimination. In other words, the step of diverting, diverts the already discriminated first type of plastic material. By diverting is meant that the first type of plastic material is separated from the other types of material into different streams or fractions. The first type of plastic material may be removed from the mixed waste material stream. Other types of material may be removed from the mixed waste material stream.

The material items in the first type of plastic material fraction are subjected to a step of reducing a size of the material items. This step results in that the material items may be more exposed and hence accessible for the washing process. In the step of subjecting the first type of plastic material fraction to a washing process it may go through an alkaline washing process or a washing process at an elevated temperature, or a combination thereof. The washing process may remove dirt, dust residues, adhesives and/or labels. The smaller size of the material items in the first type of plastic material fraction may facilitate the washing process. The washing process may be adapted to the type of plastic material. By washing the first type of plastic material fraction the purity level of the end product, the purified plastic material, may be further improved.

Subsequent to the washing process the material items of the washed first type of plastic material fraction are once again discriminated, where the first type of plastic material is discriminated from other types of material. The other types of material may be material that has been separated from the first type of plastic material during the size reducing step or the washing step. The discriminated first type of plastic material is then diverted from material of other types based on the discrimination. Thus, the first type of plastic material is separated from other material into the purified plastic material. Hence, the second steps of discriminating and diverting further enhances the purity of the first type of plastic material.

The first type of plastic material may be a first type of high impact polystyrene material, such that a purified high impact polystyrene material is obtained.

High impact polystyrene material is a economically valuable material especially when it may be sorted out after type into fraction with a high purity. Therefore, a method suitable for sorting out high impact polystyrene material may provide possibilties to reuse the material as discussed above for the plastic material.

The elevated temperature in the washing process may be in the interval of 30°-80° and preferably in the interval of 40°-60°.

The method may further comprise discriminating a second type of plastic material from other types of material in the material stream from which the first type of plastic material has been diverted, using a near infrared spectroscopy system and/or a visible spectroscopy system, diverting the second type of plastic material from other types of material in the material stream into a second plastic material fraction, thereby sorting out material of the second type of plastic material from the material stream, reducing a size of material items in the second type of plastic material fraction, subjecting the second type of plastic material fraction to an alkaline washing process and/or a washing process at an elevated temperature, discriminating said second type of plastic material in the washed second type of plastic material fraction from other types of material using a near infrared spectroscopy system and/or a visible spectroscopy system, and diverting said second type of plastic material in the washed second type of plastic material fraction from other types of material, thereby sorting out other types of material from the washed second type of plastic material fraction while obtaining a second purified plastic material.

It may be advantageous to add second discriminating and diverting steps for sorting out a second type of plastic material since it allows the method to handle more kinds of materials at the same time which further enhances the efficiency of the method. The recycling levels may also be increased through sorting out a second type of plastic material. The further steps may also decrease the labour intensity of the method because of the decrease of necessity to move the material that was not of the first type of plastic material to go through the method a second time with a different setting for what type of material that is sorted. Another advantage resides in that settings, for which type of material that is sorted and settings for the washing may not need to be changed as often as well.

The step of discriminating a second type of plastic material from other types of mixed waste material in the material stream is typically performed when the first type of plastic material has already been diverted form the mixed waste material stream. The second type of plastic material that is discriminated and diverted typically goes through an equal purifying process as the first type of plastic material. As an example, the first type of plastic material may be of white colour while the second type of plastic material may be of another colour. The settings for the respective discrimination steps are typically set to match the respective demanded types of plastic material. The step of reducing the material size and the step of subjecting the material for a washing process may also have different settings dependent on the type of plastic material. In other words, the settings used for the second type of plastic material may be different compared to the corresponding settings for the first type of plastic material. As an example, the size may differ, or the temperature may differ. n

The second type of plastic material may be a second type of high impact polystyrene material, such that a second purified high impact polystyrene material is obtained.

The second type of high impact polystyrene material provides similar advantages as discussed above related to the first type of high impact polystyrene material.

If a further type or further types of plastic material are to be sorted out the method may be expanded to include further discrimination and diverting steps of the mixed waste material stream. Such further type or types of plastic material may be subjected to a substantially equal purifying process as the one of the first or second type of plastic material. In other words, the method may further comprise, discriminating a further type of plastic material from other types of material in the material stream from which the second type of plastic material has been diverted, using a near infrared spectroscopy system and/or a visible spectroscopy system, diverting the further type of plastic material from other types of material in the material stream into a further plastic material fraction, thereby sorting out material of the further type of plastic material from the material stream, reducing a size of material items in the further type of plastic material fraction, subjecting the further type of plastic material fraction to an alkaline washing process and/or a washing process at an elevated temperature, discriminating said further type of plastic material in the washed further type of plastic material fraction from other types of material using a near infrared spectroscopy system and/or a visible spectroscopy system, and diverting said further type of plastic material in the washed further type of plastic material fraction from other types of material, thereby sorting out other types of material from the washed further type of plastic material fraction while obtaining a further purified plastic material.

As is understood by the skilled person, the method may be adapted to obtain any needed or desired number of purified plastic materials. By sorting out more types of plastic material the method is easily adapted to the kind of sorting system that is required in a specific area or country.

The further type of plastic material may be a further type of high impact polystyrene material, such that a further purified high impact polystyrene material is obtained.

The purified plastic material and, if present, the second purified plastic material, may be a food grade plastic material.

By sorting out food grade plastic material it may be recycled into new food plastic material applications. The material for food packages has certain requirements which result in that not all plastics are suitable for usage in a recycled food package. When the food grade plastic material is sorted the quality of the material may be ensured and it is possible to use the recycled material for new food applications. Recycled packaging is a coveted product that may reduce the environmental impact. Therefore, being able to obtain a purified food grade plastic material may be advantageous.

The method may further comprise prior to reducing the size of material items in the first type of plastic material fraction, and if present, the second type of plastic material fraction, discriminating the first type of plastic material from other types of material in the first type of plastic material fraction using a near infrared spectroscopy system and/or a visible spectroscopy system, diverting other types of material from the first type of plastic material in the first type of plastic material fraction, thereby purifying the first type of plastic material fraction, and if the second type of plastic material fraction is present discriminating the second type of plastic material from other types of material in the second type of plastic material fraction using a near infrared spectroscopy system and/or a visible spectroscopy system, and diverting other types of material from the second type of plastic material in the second type of plastic material fraction, thereby purifying the second type of plastic material fraction.

It may be advantageous to allow each type of plastic material fraction to go through second discriminating and diverting steps before the size is reduced, as it further enhances the purity level of each type of plastic material by sorting out material that may have ended up in the wrong fraction. The diverting step separate the other types of material from each type of plastic material fraction.

Each type of plastic material fraction may be subjected to numerous of discrimination and diverting steps to further clean each type of plastic material fraction. As earlier discussed, the diverting step is performed based on the information from the discrimination step.

The method may further comprise discriminating the first type of plastic material, and if present, the second type of plastic material, from other types of material in the material stream from which the first type of plastic material has been diverted, or if the second type of plastic material is present, from which the second type of plastic material has been diverted, using a near infrared spectroscopy system and/or a visible spectroscopy system, and diverting the first type of plastic material, and if present the second type of plastic material from other types of material in the material stream into a recovery plastic material fraction that is re-joined with the initial mixed waste material stream.

It may be advantageous to have a discriminating and diverting step of the material in the mixed waste material stream subsequent to when all the types of plastic material has been diverted. Thereby, material items of each type of plastic material may be sorted out and reintroduced into the start of the mixed waste material stream. The material items of each type of plastic material may because of various reasons not be discriminated or diverted when they should have been. This may be due to stacking of material items which may not allow all of them to be discriminated or due to a miss in a diverting step. Thus, providing the material items that were missed under the first steps of discrimination and diverting with a further chance to be discriminated and diverted into the right type of plastic material further enhances the recycling levels of the method. This loop may continue until the material item is correctly sorted. Therefore, both increasing the effectiveness and the yield of the method.

The step of reducing the size of material items may comprise shredding of material of the first type of plastic material fraction and, if present, the second type of plastic material fraction.

It may be advantageous to use shredding for reducing the size of the material items since it is a well-known and cost-efficient method. The shredding may typically be done by a shredder.

The material items may have a size with a maximum cross-sectional extension that may be at most 18 mm, subsequent to the step of reducing the size of material items.

It may be advantageous to reduce the maximum cross-sectional extension to below 18 mm as it may increase the rate of success when discriminating and diverting the type of plastic material into the purified plastic material. The reduced size may also facilitate the washing process. The reduced size may also increase the chance of a single material in the material items which have been subjected to the size reduction.

The purified plastic material, and if present, the second purified plastic material, may have a material purity level of at least 95%, preferably of at least 98%.

It may be advantageous with a material purity level of at least 95% as it further ensures a relatively speaking high quality of the recycled material.

The step of subjecting the first type of plastic material fraction, and if present, the second type of plastic material fraction, to the alkaline washing process may further comprise subjecting the first type of plastic material fraction, and if present, the second type of plastic material fraction, to a washing fluid comprising natrium hydroxide and having a pH between 8 and 13, preferably between 9-11.

It may be advantageous with an alkaline washing process with a pH between 8 and 13 since the alkaline washing process may assist in removing dirt, labels, and signs from the material items. The pH level may be adapted to the type of plastic material that are washed or to the type of material that should be removed.

The method may further comprise subjecting the first type of plastic material fraction, and if present, the second type of plastic material fraction, to a floating separation process, thereby separating material with a density higher than that of water from material with a density lower than that of water.

It may be advantageous with a floating separation process since it may separate lighter material from more dense material, which further may improve the purity level of the purified plastic material. By subjecting the material items for a floating separation process it also provides an alternative method for sorting out different types of material. Material of a type will either float or sink, thereby sorting it out based on its density.

The method may further comprise, subsequent to subjecting the first type of plastic material fraction, and if present, the second type of plastic material fraction, to the washing process, drying of material in the first type of plastic material fraction, and if present, in the second type of plastic material fraction.

It may be advantageous to dry the material before it enters the last discriminating and diverting steps due to that material items may get stuck to each other in their wet condition. Wet items may have a tendency to stick to each other or to other entities which may result in that it is harder to divert the correct material item. By drying the material items the level of purity of the obtained plastic material may be further increased.

The method may further comprise at least one of, prior to discriminating the first type of plastic material, separating ferrous material from the mixed waste material stream using a magnet arrangement, and separating non-ferrous material from the mixed waste material stream using an eddy current seperator.

It may be advantageous to separate the ferrous material from the mixed waste material stream due to the value of many of the ferrous materials. By separating the ferrous material it may be recycled and the profit of the method may be further increased. Sorting out ferrous material may also result in a decrease of material downstream in the mixed waste material stream which may further facilitate the discrimination steps.

It may be advantageous to separate non-ferrous material from the mixed waste material stream due to the value of many of the non-ferrous materials. By separating the non-ferrous material it may be recycled and the profit of the method may be further increased. Sorting out non-ferrous material may also result in a decrease of material downstream in the mixed waste material stream which may further facilitate the discrimination steps.

The discriminating steps may comprise acquiring a spectrum of objects originating from the material stream and the diverting steps may comprise diverting the objects originating from the material stream based on the acquired spectrum.

When the discriminating process acquires a spectrum it may be compared against a database with spectra or against simplified spectra or by an exclusion method to decide which objects that should be diverted. As an example, the database may have a range of spectrums that are considered as one type of plastic material and if the spectrum matches any of these it is diverted. Another example is when simplified spectrums are used, where some properties in the spectrum profile is searched and if the acquired spectrum matches this property it is diverted. The objects that originate from the material stream may be in the mixed waste material stream itself or in any of the subsequent fractions that are sorted e.g. the first type of plastic material fraction or the washed first type of plastic material fraction.

The method may further comprise, prior to discriminating the first type of plastic material, separating the mixed waste material stream based on the cross-sectional extension.

This may be advantageous as material items smaller or larger than a predetermined cross-sectional extension may be separated from the start. Many of the smaller material such as gravel and sand may be separated from the mixed waste material stream through such sorting. Also, material items with a larger cross-sectional extension may be separated as well, which may further enhance the discriminating process and avoid that the larger material items cover other material item and thereby not allowing them to be discriminated.

The method may further comprise, prior to discriminating the first type of plastic material, separating the mixed waste material stream based on a weight of each object in the mixed waste material stream using a wind sifter.

According to a second aspect a system for obtaining a purified plastic material from a mixed waste material stream, the system comprising; a first classification and sorting arrangement, a material item size reduction arrangement, a washing arrangement, and a purifying classification and sorting arrangement, wherein the first classification and sorting arrangement comprises, a first classification and sorting station configured to receive the mixed waste material stream, the first classification and sorting station comprises a near infrared, NIR, spectroscopy system and/or a visible spectroscopy system configured to discriminate a first type of plastic material from other types of material in the material stream, and an ejection unit configured to divert the first type of plastic material from other types of material in the material stream into a first plastic material fraction, thereby sorting out material of the first type of plastic material from the material stream, wherein the material item size reduction arrangement comprises a first shredder configured to receive the first plastic material fraction and to decrease the size of material items in the first type of plastic material fraction, wherein the washing arrangement comprises, a first washing station configured to receive the first type of plastic material fraction from the material item size reduction arrangement and to wash the plastic material fraction in an alkaline washing process and/or a washing process at an elevated temperature, and wherein the purifying classification and sorting arrangement comprises a first purifying classification and sorting station configured to receive the washed first type of plastic material fraction from the first washing arrangement, the first purifying classification and sorting station comprises a near infrared, NIR, spectroscopy system and/or a visible spectroscopy system configured to discriminate said first type of plastic material from other types of material in the washed first type of plastic material fraction, and an ejection unit configured to divert the first type of plastic material from other types of material, thereby sorting out other types of material from the washed first type of plastic material fraction, thereby obtaining the purified plastic material.

In general, features of this aspect provide similar advantages as discussed above in relation to the previous aspects of the invention. The features of the method may be provided for the system by themselves or as combination. Consequently, said features and advantages will not be repeated in order to avoid undue repetition.

A further scope of applicability of the present invention will become apparent from the detailed description given below. However, it should be understood that the detailed description and specific examples, while indicating preferred variants of the present inventive concept, are given by way of illustration only, since various changes and modifications within the scope of the inventive concept will become apparent to those skilled in the art from this detailed description.

Hence, it is to be understood that this inventive concept is not limited to the particular component parts of the device described as such device may vary. It is also to be understood that the terminology used herein is for purpose of describing particular variants only and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements.

### BRIEF DESCRIPTION OF THE DRAWINGS

The aspects of the present inventive concept, including its particular features and advantages, will be readily understood from the following detailed description and the accompanying drawings. The figures are provided to illustrate the general structures of the present inventive concept. Like reference numerals refer to like elements throughout.

FIG. 1 is a flow chart over a system for obtaining a purified plastic material from a mixed waste material stream.

FIG. 2 is a flow chart over a system for obtaining a purified plastic material from a mixed waste material stream with further stations in the system as compared to the system of FIG. 1.

FIG. 3 is a perspective schematic view of a classification and sorting station.

FIG. 4 is a flow chart illustrating the different steps in a method for obtaining a purified plastic material from a mixed waste material stream.

FIG. 5 is a flow chart illustrating the different steps in a method for obtaining a purified plastic material from a mixed waste material stream with further steps in the method as compared to the method of FIG. 4.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

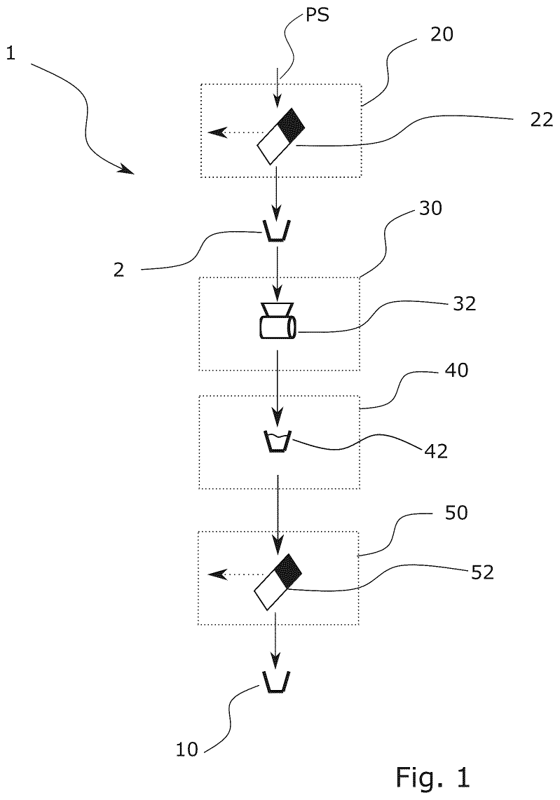

FIG. 1 illustrates a flow chart of a system 1 for obtaining a purified plastic material 10 from a mixed waste material stream PS. The system 1 comprises a first classification and sorting arrangement 20, a material item size reduction arrangement 30, a washing arrangement 40, and a purifying classification and sorting arrangement 50. At the first classification and sorting arrangement 20 a first sorting is provided. A first classification and sorting station 22, in the first classification and sorting arrangement 20, receives the mixed waste material stream PS. The input material, that is the mixed waste material stream PS, may originate from bales of mixed waste material or bales of plastic material. However, it should be noted that if the plastic material is a high impact polystyrene material, the origin of the material may be from municipal solid waste that has already been sorted in a municipal solid waste plant and it may be bales of mixed polystyrene material that is sorted.

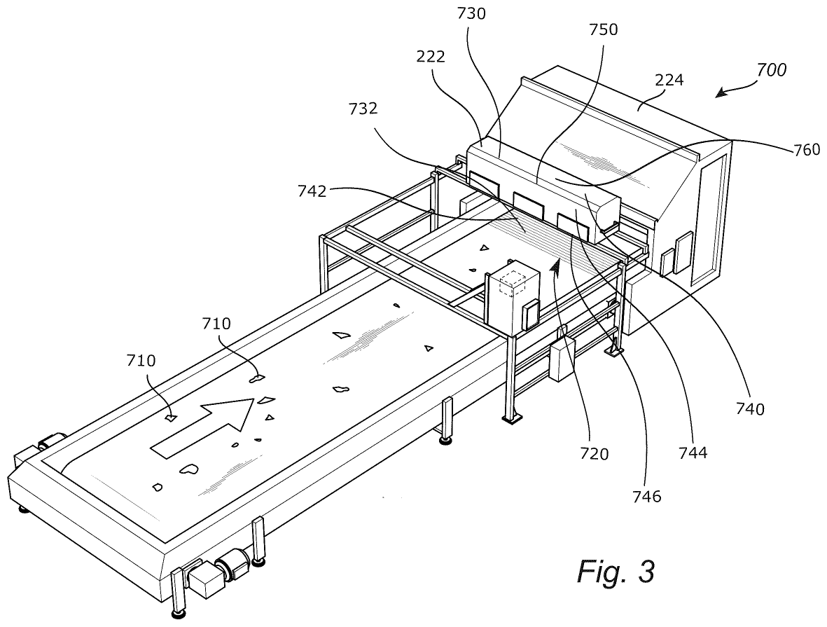

Now also referring to FIG. 3, the first classification and sorting station 22 comprises a near infrared, NIR, spectroscopy system 222 and/or a visible spectroscopy system configured to discriminate a first type of plastic material from other types of material in the material stream PS, and an ejection unit 224 configured to divert the first type of plastic material from other types of material in the material stream PS into a first plastic material fraction 2. When discriminating the first type of plastic material from other types of material the discrimination may be done dependent on the composition of a first type of plastic material. The material type may also be combined with a colour, such that a first type of plastic material may be of a specific composition with a specific colour. After the first type of plastic material has been discriminated it is diverted into the first type of plastic material fraction 2 based on the information from the discrimination. In other words, the first classification and sorting station 22 diverts the already discriminated first type of plastic material. In yet other words, the first classification and sorting station 22 diverts the already discriminated first type of plastic material from other materials present in the mixed waste material stream PS. By diverting is meant that the first type of plastic material is separated from the other types of material into different streams or fractions. The first type of plastic material may be removed from the mixed waste material stream PS, or other types of material may be removed from the mixed waste material stream PS. The other materials that are diverted from the classification and sorting station is represented in the figures by a dotted arrow. All the classification and sorting stations in the system 1 may be the same type of station. In other words, the same type of station may be at multiple positions in the system. An example of such a station will be further described in connection to FIG. 3.

The first type of plastic material fraction 2 is received by the material item size reduction arrangement 30. At the material item size reduction arrangement 30 the size of the material items in the first type of plastic material fraction 2 are reduced. In the depicted system 1 of FIG. 1, the material items are shredded in the material item size reduction arrangement 30 by a shredder 32 to a smaller size. The material items may be shredded to a size with a maximum cross-sectional extension that may be at most 18 mm.

A first washing station 42 of the washing arrangement 40 receives the first type of plastic material fraction 2 from the material item size reduction arrangement 30. The fact that the material items have been shredded may result in they are more exposed and hence accessible for a washing process. The washing of the first type of plastic material fraction 2 may as depicted in FIG. 1 be in an alkaline washing process and/or a washing process at an elevated temperature. The temperature and how alkaline the washing process is dependent on what the first type of plastic material fraction 2 has for composition and/or on what kind of material that needs to be removed, by being washed away, from the first type of plastic material. The elevated temperature in the washing process may be in the interval of 30°-80° and preferably in the interval of 40°-60°. The washing fluid may comprise natrium hydroxide and have a pH between 8 and 13, preferably between 9-11. The washing process may be used to remove stickers, labels or similar on the material items in the first type of plastic material fraction 2.

Subsequent to the washing process the material items of the washed first type of plastic material fraction 2 are once again discriminated, where the first type of plastic material is discriminated from other types of material. The other types of material may be material that has been separated from the first type of plastic material during the size reducing process or the washing process. The purifying classification and sorting arrangement 50 comprises a first purifying classification and sorting station 52 configured to receive the washed first type of plastic material fraction 2 from the first washing arrangement 40. The first purifying classification sorting station 52 of FIG. 1 is of the same type as the first classification and sorting station 22. How it works will for the sake of efficiency not be repeated and the classification and sorting stations will be further described in connection to FIG. 3. A major difference between the first classification and sorting station 22 and the purifying classification and sorting station 52 is that the purifying classification and sorting station 52 is sorting out other types of material from the washed first type of plastic material fraction 2 and thereby obtaining the purified plastic material 10.

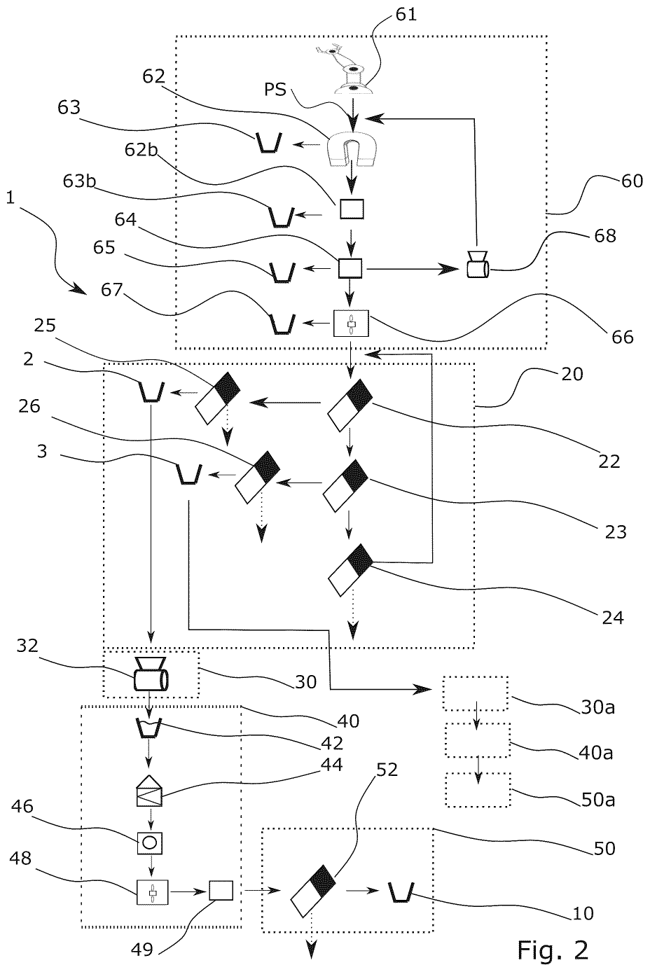

Turning to FIG. 2 an example of the system 1 for obtaining a purified plastic material 10 from a mixed waste material stream PS with further stations in the system 1 is illustrated. The stations that already has been described in connection to FIG. 1 forms part of the system 1 in FIG. 2 as well and will not be further described in this section. It should be stressed that the stations in system 1 in FIG. 1 are sufficient to reach a synergy effect when sorting the mixed waste material stream PS.

In FIG. 2 there are examples of which type of stations that may further be part of the system 1. The stations may alone form part of the system 1 in FIG. 1 or together with other stations. The stations are illustrated together to facilitate the understanding of the description. The different stations described below may be used alone or in any combination depending on the requirement of the plant in which the system 1 is operating.

The system 1 in FIG. 2 further comprises a pre-sorting arrangement 60. The pre-sorting arrangement 60 comprises a bale opener 61 that is configured to open the bales that the mixed waste material stream PS may originate from. The pre-sorting arrangement 60 further comprises a magnet arrangement 62 that is configured to separate ferrous material from the mixed waste material stream PS into a ferrous material fraction 63. Ferrous material often has a high value and by separating ferrous material it may be recycled and the profit of the system may be further increased. The pre-sorting arrangement 60 comprises an eddy current separator 62b that is configured to separate non-ferrous material from the mixed waste material stream PS into a non-ferrous material fraction 63b. Non-ferrous material or non-ferrous metals often has a high value and by separating non-ferrous material it may be recycled and the profit of the system may be further increased.

The pre-sorting arrangement 60 further comprises a screener 64 that separates material items with a maximum cross-sectional extension smaller than a pre-set screen range to a waste fraction 65 and material items with a larger maximum cross-sectional extension than the pre-set screen range to a pre-shredder 68. As an example, the pre-set screen range may be 20 mm-320 mm. The pre-shredder 68 of the pre-sorting arrangement 60 shreds the material such that the maximum cross-sectional extension is smaller than the upper value in the pre-set screen range. The shredded material items are re-introduced in the mixed waste material stream PS.

The pre-sorting arrangement 60 further comprises a wind sifter that separates film material from the mixed waste material stream PS into a film fraction 67.

At the first classification and sorting arrangement 20 a second sorting is provided by a second classification and sorting station 23 that receives the mixed waste material stream PS from the first classification and sorting station 22. The second classification and sorting station 23 comprises a near infrared, NIR, spectroscopy system 222 and/or a visible spectroscopy system configured to discriminate a second type of plastic material from other types of mixed waste material in the material stream PS, and an ejection unit 224 configured to divert the second type of plastic material from other types of material in the material stream PS into a second plastic material fraction 3, see also FIG. 3. In other words, the second classification and sorting station 23 discriminates and diverts a plastic material that is different from the first plastic material in either composition and/or colour. When the second type of plastic material has been discriminated it is diverted into the second type of plastic material fraction 3 based on the information from the discrimination. The second classification and sorting station 23 handles the mixed waste material stream PS in a similar way as the first classification and sorting station 22 with the major exception that the first type of plastic material already has been diverted and that it is a second type of plastic material that is discriminated and diverted.

As is understood by the skilled person, if the system 1 needs to sort out a further type of plastic material, a further classification and sorting station may be added to the system 1.

The classification and sorting arrangement 20 further comprises a first 25 and second 26 cleaning classification and sorting station. As the first 25 and second 26 cleaning classification and sorting station are of the same type of station as the first 22 and second 23 classification and sorting station how the stations functions will not be repeated.

The first cleaning classification and sorting station 25 is configured to sort out the first type of plastic material to further clean the first type of plastic material fraction 2.

The second cleaning classification and sorting station 26 is configured to sort out the second type of plastic material to further clean the second type of plastic material fraction 3. The first 25 and second 26 cleaning classification and sorting stations are in other words configured to divert other material from their respective type of plastic material fraction 2, 3. These steps further enhances the level of purity in the first type of plastic material fraction 2 and second type of plastic material fraction 3.

The classification and sorting arrangement 20 further comprises a recovery classification and sorting station 24, which is of the same type as the other classification and sorting stations. The recovery classification and sorting station 24 is configured to receive the mixed waste material stream PS from the second classification and sorting 23 station and to discriminate and divert the first type of plastic material and the second type of plastic material such that these types of plastic material is reintroduced into the mixed waste material stream PS that enters the first classification and sorting station 22. The material items of each type of plastic material may because of various reasons not be discriminated or diverted when they should have been, i.e. earlier in the process. This may be due to stacking or sticking of material items which may not allow all of them to be discriminated or due to a miss in a diverting step. Thus, providing the material items that were missed under the first steps of discrimination and diverting with a further chance to be discriminated and diverted into the right type of plastic material further enhances the recycling levels of the method. This loop may continue until the material items is correctly sorted.

Hereafter when the different arrangements and stations that handles the first type of plastic material fraction 2 and second type of plastic material fraction 3 will be described, only the arrangements and stations that handles the first type of plastic material fraction 2 will be described. The second type of plastic material fraction 3 passes through substantially the same type of arrangement and stations. In FIG. 2 only the arrangements as such are illustrated for the second type of plastic material fraction 3. More specifically, a second material item size reduction arrangement 30a, a second washing arrangement 40a and a second purifying classification and sorting arrangement 50a are schematically illustrated in FIG. 2.

The material size of the first type of plastic material fraction 2 is, as described in connection to FIG. 1, reduced in the material item size reduction arrangement 30 before it enters the washing arrangement 40. The washing arrangement 40 comprises the first washing station 42 as described in connection to FIG. 1. The washing arrangement 40 further comprises a density separation station 44. The density separation station 44 receives the cleaned first type of plastic material fraction 2 from the first washing station 42 and separates material with a density higher than that of water from material with a density lower than that of water. It may be advantageous with a floating separation process since it may separate lighter material from more dense material, which further may improve the purity level of the purified plastic material 10. By subjecting the material items to a floating separation process it also provides an alternative method for sorting out different types of material. Material of a type will either float or sink, thereby sorting it out based on its density.

The wet material items from the washing station may have a tendency to stick to each other or to other entities which may result in that it is harder to divert the correct material item. Therefore, a first drying station 46 is added to the washing arrangement 40 of the system 1. The first drying station 46 dries the first type of plastic material fraction 2. The drying may be performed using air circulation and/or an elevated temperature or other known methods for drying. The dried material items of the first type of plastic material fraction are then subjected to two steps of sorting. The first step of sorting is performed in a first wind sifter 48 of the washing arrangement 40 where air is used to separate lighter material from denser material by using compressed air that blows the lighter material away. The first wind sifter 48 receives the first type of plastic material fraction 2 from the first drying station 46. The second step of sorting is performed in a first screener 49 of the washing arrangement 40 that sort material items based on its cross-sectional size. The first screener 49 receives the first type of plastic material fraction 2 from the first wind sifter 48.

Finally, the purifying arrangement 50 receives the first type of plastic material fraction 2 from the washing arrangement 40. The purifying arrangement 50 in FIG. 2 is substantially the same as the one in FIG. 1.

It should be noted that even thou plastic material have been used throughout the description, the plastic material may be a specific plastic material such as high impact polystyrene, or a food-grade plastic material, or a food grade high impact polystyrene. The system described above functions for these types of plastic material as well.

Turning to FIG. 3 a perspective schematic view of a classification and sorting station 700 is illustrated. The first 22 and second 23 classification and sorting stations, the recovery classification and sorting stations 24, the first 25 and second 26 cleaning particulate classification and sorting stations, and the first purifying classification and sorting station 52 may all be of the same type as the classification and sorting station 700 that is described here. Each of said stations may have one or more of the features described below. However, in the following the station 700 is for reasons of simplicity described as a classification and sorting station 700.

The classification and sorting station 700 is fed with pieces or items of material 710. The pieces of material 700 are conveyed through a detection zone 720. However, the pieces of material 700 may be provided through the detection zone 720 by any suitable mean or manually without any technical means. A light source arrangement 730 and a NIR spectroscopy system 222 are provided. The spectroscopy system 222 is adapted to receive and analyse light 732, from the light source arrangement 730, which is reflected and/or scattered by the pieces of material 710 in the detection zone 720. Hence, the NIR spectroscopy system 222 typically acquires a spectrum of the pieces of material 710 from the stream of material that is conveyed through the detection zone 720. The NIR spectroscopy system 222 of the classification and sorting station 700 is configured to discriminate a first type of plastic material from other materials, such as plastic materials, based on the acquired spectrum. In other words, the NIR system 222 is typically set up such that a specific type of plastic material is discriminated from other types of material owing from its spectrum.

The classification and sorting stations may further comprise a light spectroscopy system 760 configured to acquire a spectrum of plastic material originating from the stream of material PS that is conveyed through the detection zone 720. The ejection unit 224 of the classification and sorting station 700 may be further configured to divert said type of plastic material originating from the mixed waste material stream PS based on the acquired spectrum thereby sorting the first type of plastic material fraction based on its colour.

The light spectroscopy system 760 may through the acquired spectrum determine the different colours of the plastic material that is conveyed through the detection zone 720. An advantage of determining the colours of the plastic material is that it may be sorted into different fractions.

The classification and sorting station 700 may further comprise a laser triangulation system 740 configured to determine height information of material 710 that is conveyed through the detection zone 720. The ejection unit 224 of said at least one classification and sorting station may be further configured to divert said plastic material based on the determined height information.

The laser triangulation system 740 is typically configured to emit a line of laser light 742 towards the detection zone 720. The depicted laser triangulation system 740 includes a camera-based sensor arrangement 744 configured to receive and analyse light 746 which is reflected and/or scattered by the piece of material 710 in the detection zone 720. By means of the laser triangulation system 740 the classification and sorting station 700 may be able to detect plastic material that the NIR spectroscopy system 222 have difficulties to detect. One example of such plastic material may be black plastic material. By detecting height differences on a conveyor belt used to convey the material being sorted, the classification and sorting station may combine such height information with the acquired information from the NIR spectroscopy system 222 to determine if there is any black plastic material or plastic material that is hard to detect on the conveyor belt. Accordingly, further plastic material may be recycled.

The classification and sorting station 700 may further comprise a camera 750 configured to acquire images of plastic material originating from the stream of material that is conveyed through the detection zone 720. The classification and sorting station 700 may comprise an artificial neural network in combination with the camera 750. Such artificial neural network may be configured to detect different characteristics of plastic material that is conveyed through the detection zone 720 based on images acquired by the camera 750. The ejection unit 224 of the classification and sorting station 700 may in this case be further configured to divert plastic material that is conveyed through the detection zone 720 based on the detected characteristics of plastic material. In other words, characteristics of plastic material may thus be determined by the artificial neural network from the, by the camera, acquired images. The characteristics may be a shape, a colour, features at the surface or anything in the visual appearance of the plastic material that may be determined and classified by the artificial neural network. The camera 750 may provide the possibility to further sort the material into different fractions. With the help of the artificial neural network it may be possible to sort plastic material of the same material composition into different fractions depending on quality and origin.

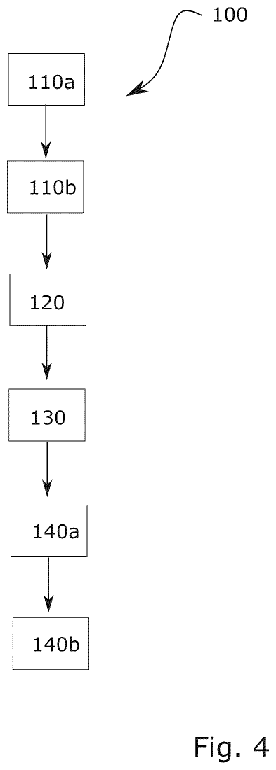

Now turning to FIG. 4, a method 100 for obtaining a purified plastic material 10 from a mixed waste material stream PS will now be described. The method 100 starts by discriminating 110a a first type of plastic material from other types of material in the material stream using PS a near infrared spectroscopy system 222 and/or a visible spectroscopy system.

The method 100 proceeds with diverting 110 the first type of plastic material from other types of mixed waste material in the material stream into a first plastic material fraction 2, thereby sorting out material of the first type of plastic material from the material stream.

The method 100 proceeds with reducing 120 a size of material items in the first type of plastic material fraction 2.

The method 100 proceeds with subjecting 130 the first type of plastic material fraction 2 to an alkaline washing process and/or a washing process at an elevated temperature.

The method 100 proceeds with discriminating 140a said first type of plastic material in the washed first type of plastic material fraction 2 from other types of material using a near infrared spectroscopy system 222 and/or a visible spectroscopy system.

The method 100 proceeds with diverting 140b said first type of plastic material in the washed first type of plastic material fraction 2 from other types of material, thereby sorting out other types of material from the washed first type of plastic material fraction 2, thereby obtaining the purified plastic material 10.

It is to be noted that the steps in the steps or acts of the above method 100 may be conducted in any suitable order and hence not just in the order given above. Further, one or more of the steps or acts may be conducted in parallel. It is also to be noted that the steps or acts may be conducted by different equipment, at different times and/or at different sites. In other words, as an example, the method may be performed in a distributed manner at a plurality sites where different steps or acts are conducted at different points in time. However, the method may to advantage be conducted in the sequence described above at a single site.

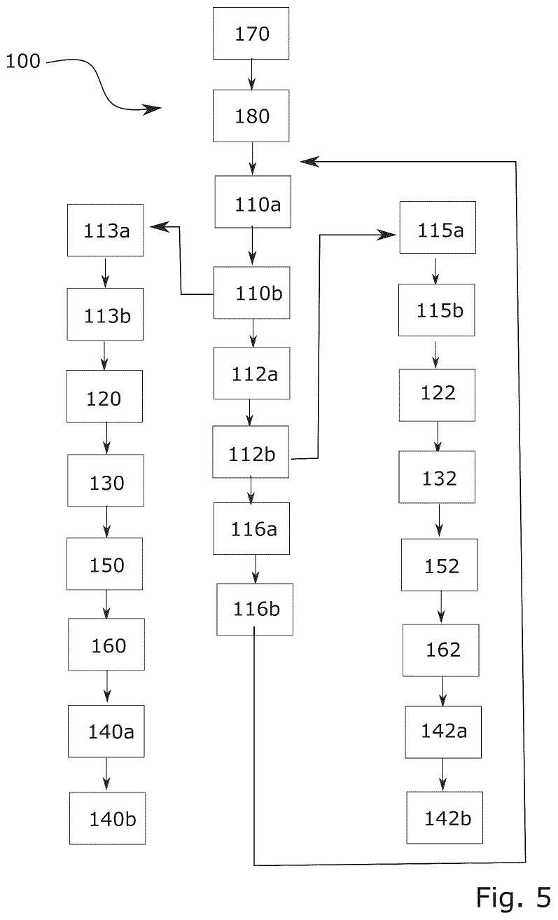

Turning to FIG. 5, the method 100 from FIG. 4 is illustrated together with a set of alternative steps. The alternative steps may be added alone or in any combination to the method 100 in FIG. 4 depending on the requirements. The steps already mentioned in connection to FIG. 4 will, for the sake of efficiency, not be described again. The method 100 further comprises a step, pre-sequent to the step of discriminating 110a, separating 170 ferrous material from the mixed waste material stream PS using a magnet arrangement 62. The method 100 further comprises a step, pre-sequent to the step of discriminating 110a, separating 180 non-ferrous material from the mixed waste material stream PS using an eddy current separator 62b.

Subsequent to the step of diverting 110b, a step of, discriminating 112a a second type of plastic material from other types of material in the material stream PS from which the first type of plastic material has been diverted, using a near infrared spectroscopy system 222 and/or a visible spectroscopy system, is provided.

The method 100 proceeds with diverting 112b the second type of plastic material from other types of mixed waste material in the material stream PS into a second plastic material fraction 3, thereby sorting out material of the second type of plastic material from the material stream PS.

The method 100 proceeds with discriminating 116a the first type of plastic material, and the second type of plastic material, from other types of material in the material stream PS from which the second type of plastic material has been diverted, using a near infrared spectroscopy system 222 and/or a visible spectroscopy system.

The method 100 proceeds with diverting 116b the first type of plastic material, and the second type of plastic material from other types of material in the material stream PS into a recovery plastic material fraction 4 that is re-joined with the initial mixed waste material stream PS.

Hereafter, the different steps for processing the first 2 and second 3 plastic material fraction will be described. For the sake of efficiency the steps will be described together. However, it should be understood that it is two different flows and that the steps are performed parallel to each other and may be performed in different stations.

The method 100 proceeds with discriminating 113a, 115a the first type of plastic material from other types of material in the first type of plastic material fraction 2 and the second type of plastic material fraction 3 using a near infrared spectroscopy system 222 and/or a visible spectroscopy system. The method 100 proceeds with diverting 113b, 115b other types of material from the first type of plastic material in the first type of plastic material fraction 2 and the second type of plastic material fraction 3, thereby purifying the first type of plastic material fraction 2 and second type of plastic material fraction 3.

The method 100 proceeds with subjecting 150, 152 the first type of plastic material fraction 2 and the second type of plastic material fraction 3 to a floating separation process, thereby separating material with a density higher than that of water from material with a density lower than that of water.

The method proceeds with drying 160, 162 of material in the first type of plastic material fraction 2 and the second type of plastic material fraction 3.

It is to be noted that the steps in the steps or acts of the above method 100 may be conducted in any suitable order and hence not just in the order given above. Further, one or more of the steps or acts may be conducted in parallel. It is also to be noted that the steps or acts may be conducted by different equipment, at different times and/or at different sites. In other words, as an example, the method may be performed in a distributed manner at a plurality sites where different steps or acts are conducted at different points in time. However, the method may to advantage be conducted in the sequence described above at a single site.

Additionally, variations to the disclosed variants can be understood and effected by the skilled person in practicing the claimed invention, from a study of the drawings, the disclosure, and the appended claims. In the claims, the word “comprising” does not exclude other elements, and the indefinite article “a” or “an” does not exclude a plurality. The mere fact that certain measures are recited in mutually different dependent claims does not indicate that a combination of these measured cannot be used to advantage.

1. A method for obtaining a purified plastic material, such as a high impact polystyrene material, from a mixed waste material stream, the method comprising,
discriminating a first type of plastic material from other types of material in the material stream using a near infrared spectroscopy system and/or a visible spectroscopy system,
diverting the first type of plastic material from other types of material in the material stream into a first plastic material fraction, thereby sorting out material of the first type of plastic material from the material stream,
reducing a size of material items in the first type of plastic material fraction,
subjecting the first type of plastic material fraction to an alkaline washing process and/or a washing process at an elevated temperature,
discriminating said first type of plastic material in the washed first type of plastic material fraction from other types of material using a near infrared spectroscopy system and/or a visible spectroscopy system, and
diverting said first type of plastic material in the washed first type of plastic material fraction from other types of material, thereby sorting out other types of material from the washed first type of plastic material fraction, thereby obtaining the purified plastic material.

2. The method according to claim 1, wherein the first type of plastic material is a first type of high impact polystyrene material, such that a purified high impact polystyrene material is obtained.

3. The method according to claim 1, further comprising,
discriminating a second type of plastic material from other types of material in the material stream from which the first type of plastic material has been diverted, using a near infrared spectroscopy system and/or a visible spectroscopy system,
diverting the second type of plastic material from other types of material in the material stream into a second plastic material fraction thereby sorting out material of the second type of plastic material from the material stream,
reducing a size of material items in the second type of plastic material fraction,
subjecting the second type of plastic material fraction to an alkaline washing process and/or a washing process at an elevated temperature,
discriminating said second type of plastic material in the washed second type of plastic material fraction from other types of material using a near infrared spectroscopy system and/or a visible spectroscopy system, and
diverting said second type of plastic material in the washed second type of plastic material fraction from other types of material, thereby sorting out other types of material from the washed second type of plastic material fraction while obtaining a second purified plastic material.

4. The method according to claim 3, wherein the second type of plastic material is a second type of high impact polystyrene material, such that a second purified high impact polystyrene material is obtained.

5. The method according claim 1, wherein the plastic material and, if present, the second plastic material, is a food grade plastic material.

6. The method according to claim 1, further comprising, prior to reducing the size of material items in the first type of plastic material fraction, and if present, the second type of plastic material fraction,
discriminating the first type of plastic material from other types of material in the first type of plastic material fraction using a near infrared spectroscopy system and/or a visible spectroscopy system,
diverting other types of material from the first type of plastic material in the first type of plastic material thereby purifying the first type of plastic material fraction,
and if the second type of plastic material fraction is present,
discriminating the second type of plastic material from other types of material in the second type of plastic material fraction using a near infrared spectroscopy system and/or a visible spectroscopy system, and
diverting other types of material from the second type of plastic material in the second type of plastic material fraction, thereby purifying the second type of plastic material fraction.

7. The method according to claim 1, further comprising,
discriminating the first type of plastic material, and if present, the second type of plastic material, from other types of material in the material stream from which the first type of plastic material has been diverted, or if the second type of plastic material is present, from which the second type of plastic material has been diverted, using a near infrared spectroscopy system and/or a visible spectroscopy system, and
diverting the first type of plastic material, and if present the second type of plastic material from other types of material in the material stream into a recovery plastic material fraction that is re-joined with the initial mixed waste material stream.

8. The method according to claim 1, wherein the step of reducing the size of material items comprises shredding of material of the first type of plastic material fraction and, if present, the second type of plastic material fraction.

9. The method according to claim 1, wherein the material items have a size with a maximum cross-sectional extension that is at most 18 mm, subsequent to the step of reducing the size of material items.

10. The method according to claim 1, wherein the purified plastic material, and if present, the second purified plastic material, has a material purity level of at least 95%, preferably of at least 98%.

11. The method according to claim 1, wherein the step of subjecting the first type of plastic material fraction, and if present, the second type of plastic material fraction, to the alkaline washing process comprises subjecting the first type of plastic material fraction. and if present, the second type of plastic material fraction to a washing fluid comprising natrium hydroxide and having a pH between 8 and 13, preferably between 9 and 11.

12. The method according to claim 1, further comprising subjecting the first type of plastic material fraction, and if present, the second type of plastic material fraction, to a floating separation process, thereby separating material with a density higher than that of water from material with a density lower than that of water.

13. The method according to claim 1, further comprising, subsequent to subjecting the first type of plastic material fraction, and if present, the second type of plastic material fraction, to the washing process,
drying, of material in the first type of plastic material fraction, and if present, in the second type of plastic material fraction.

14. The method according to claim 1, further comprising at least one of, prior to discriminating the first type of plastic material,
separating ferrous material from the mixed waste material stream using a magnet arrangement, and
separating non-ferrous material from the mixed waste material stream using an eddy current seperator.

15. The method according to claim 1, wherein the discriminating steps comprises acquiring a spectrum of objects originating from the material stream and wherein the diverting steps comprises diverting the objects originating from the material stream based on the acquired spectrum.

16. A system for obtaining a purified plastic material from a mixed waste material stream, the system comprising;
a first classification and sorting arrangement,
a material item size reduction arrangement,
a washing arrangement, and
a purifying classification and sorting arrangement,
wherein the first classification and sorting arrangement comprising, a first classification and sorting station configured to receive the mixed waste material stream, the first classification and sorting station comprising a near infrared, NIR, spectroscopy system and/or a visible spectroscopy system configured to discriminate a first type of plastic material from other types of material in the material stream, and an ejection unit configured to divert the first type of plastic material from other types of material in the material stream into a first plastic material fraction, thereby sorting out material of the first type of plastic material from the material stream,
wherein the material item size reduction arrangement comprises a first shredder configured to receive the first plastic material fraction and to decrease the size of material items in the first type of plastic material fraction,
wherein the washing arrangement comprising, a first washing station configured to receive the first type of plastic material fraction from the material item size reduction arrangement and to wash the plastic material fraction in an alkaline washing process and/or a washing process at an elevated temperature, and
wherein the purifying classification and sorting arrangement comprising a first purifying classification and sorting station configured to receive the washed first type of plastic material fraction from the first washing arrangement, the first purifying classification and sorting station comprising a near infrared, NIR, spectroscopy system and/or a visible spectroscopy system configured to discriminate said first type of plastic material from other types of material in the washed first type of plastic material fraction, and an ejection unit configured to divert the first type of plastic material from other types of material, thereby sorting out other types of material from the washed first type of plastic material fraction, thereby obtaining the purified plastic material.
